(19) United States
(12) Patent Application Publication
(10) Pub. No.: US 2008/0305876 A1
(43) Pub. Date: Dec. 11, 2008

(54) METHOD AND SYSTEM FOR RESPONSE AUTHORIZATION

(75) Inventors: James G. Withers, Chesterfield, MO (US); Michael S. Gramelspacher, Fairview Heights, IL (US); Rory T. Sledge, O'Fallon, IL (US)

Correspondence Address: SCHWEGMAN, LUNDBERG & WOESSNER, P.A., P.O. BOX 2938, MINNEAPOLIS, MN, 55402, US

(73) Assignee: Koplar Interactive Systems International, L.L.C., St. Louis, MO (US)

(21) Appl. No.: 12/133,428

(22) Filed: Jun. 5, 2008

Related U.S. Application Data
(60) Provisional application No. 60/942,639, filed on Jun. 7, 2007.

(51) Int. Cl. G08B 5/22; G08C 19/00; A63F 9/24

(52) U.S. Cl. 463/42; 340/7.2; 340/5.8

(57) ABSTRACT

A method and system for response authorization. In one embodiment, authorization data and response data may be received over a paging network on a user device. The authorization data may be compared against a device identifier of the user device. A response indicated by the response data may be triggered on the user device based on a comparison of the authorization data to the device identifier.

### CROSS-REFERENCE TO A RELATED APPLICATION

This application claims the benefit of United States Provisional Patent Application entitled “Method and System for Response Authorization”, Ser. No. 60/942,639, filed 7 Jun. 2007, the entire contents of which are herein incorporated by reference.

### BRIEF DESCRIPTION OF THE DRAWINGS

Some embodiments are illustrated by way of example and not limitation in the figures of the accompanying drawings in which:

FIG. 1 is a block diagram illustrating an authorization system according to an example embodiment;

FIG. 2 is a block diagram illustrating an example encoder that may be deployed in the authorization system of FIG. 1;

FIG. 3 is a block diagram illustrating an example user device that may be deployed in the authorization system of FIG. 1;

FIG. 4 is a flowchart illustrating a method for sending transmission data according to an example embodiment;

FIGS. 5-7 are flowcharts illustrating a method for triggering a response according to an example embodiment; and

FIG. 8 is a block diagram diagrammatic representation of machine in the example form of a computer system within which a set of instructions, for causing the machine to perform any one or more of the methodologies discussed herein, may be executed.

### DETAILED DESCRIPTION

Example methods and systems for response authorization are described. In the following description, for purposes of explanation, numerous specific details are set forth in order to provide a thorough understanding of example embodiments. It will be evident, however, to one skilled in the art that the present invention may be practiced without these specific details.

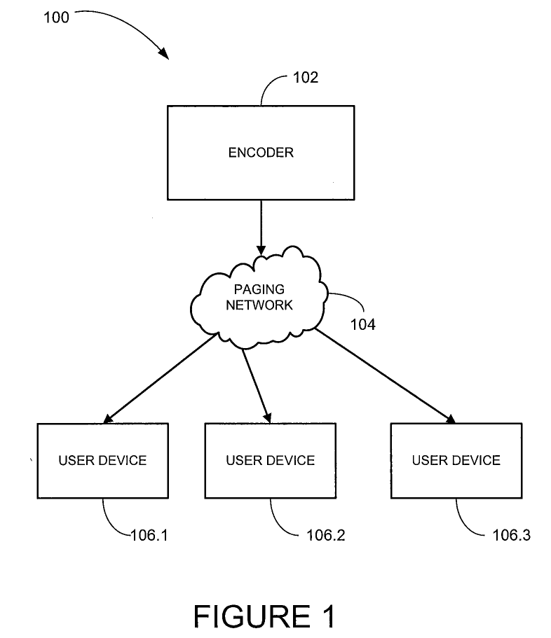

FIG. 1 illustrates an authorization system 100 in which an encoder 102 may communicate over a paging network 104 with a plurality of user devices 106.1-106.n. The paging network 104 may be a one-way paging network or other type of network. For example, the encoder 102 may send one-way network transmission data to a user device 106 but the user device 106 may not unable to respond to the encoder 102 over the paging network 104. The paging network 104 may be a wide-range network or a close-range network.

The user device 106 may be a promotional device or other type of consumer device. For example, the promotional device may be affixed to the top of a bottom or can and may include a representation of a person, animal, or other object. The user device 106 may be capable of triggering a promotional opportunity in response to programming material (e.g., audio and/or video programming) broadcast from a television station, satellite radio, and the like.

The user device 106 may include a device identifier or a tiered set of identifiers to distinguish the user device 106 from other user devices 106. The tiered set of identifiers may enable transmission data containing an addressable code to be received from the encoder 102 that has been targeted to different number of different types of user devices 106. The tiered set of identifiers may enable a global identifier to be sent to all of the user devices 106 or a unique identifier to be sent to a specific user device 106. For example, a first addressable code may be used to match a first number of the user devices 106 and a second address coded may be used to match a second number of the user devices 106.

In an example embodiment, a first addressable code may trigger a response on every one of the user devices 106, a second addressable code may trigger a response on 50,000 of the user devices 106, a third addressable code may trigger a response on 10,000 of the 50,000 addressable user devices 106, a fourth addressable code may trigger a response on 250 of the 10,000 addressable user devices 106, and a fifth addressable code may trigger a response on a unique user device 106 of the 250 addressable user devices 106. Other tiered approaches using different number of tier levels and a differing number of addressable user devices 106 may also be used.

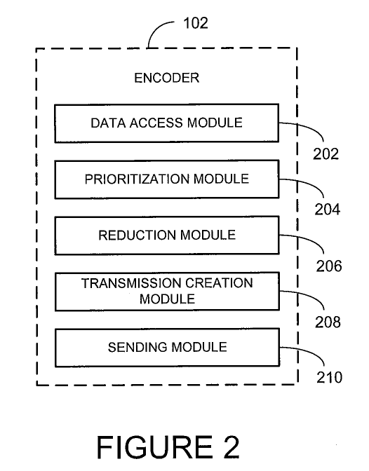

FIG. 2 is an encoding subsystem 108 that may be deployed in the encoder 102 of the authorization system 100 (see FIG. 1) or another system according to an example embodiment. The encoding subsystem 102 may include a data access module 202, a prioritization module 204, a reduction module 206, a transmission creation module 208, and/or a sending module 210. Other modules may also be included.

The data access module 202 accesses authorization data, response data and paging data. The prioritization module 204 prioritizes the response data and the paging data above the paging data for transmission to enable the response data and the paging data to be received before paging data.

The reduction module 206 reduces a packet size for the transmission data to enable the response data and paging data to be more quickly sent. The transmission creation module 208 creates the transmission data of the packet size from the authorization data, response data and paging data according to prioritization. The sending module 210 sends the transmission data over the paging network 104.

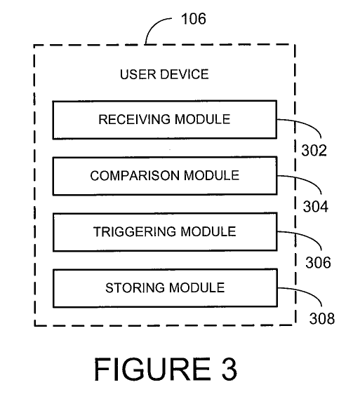

FIG. 3 is an example of the device subsystem 110 that may be deployed in the user devices 106.1-106.3 of the authorization system 100 (see FIG. 1) or another system according to an example embodiment. The device subsystem 110 may include a receiving module 302, a comparison module 304, a triggering module 306, and/or a storing module 308. Other modules may also be included.

The receiving module 302 receives authorization data (e.g., an addressable code) and response data (e.g., gaming data) over the paging network 104. The response data may optionally be received over a different network from the paging network 104.

The comparison module 304 compares the authorization data against a device identifier, the addressable code against stored data, the unique identifier against the stored data and/or the addressable code against at least one identifier of a tiered set of identifiers.

The triggering module 306 triggers a response indicated by the response data based on a comparison of the authorization data to the device identifier and/or using the gaming data based on the received response data.

The storing module 308 stores the gaming data.

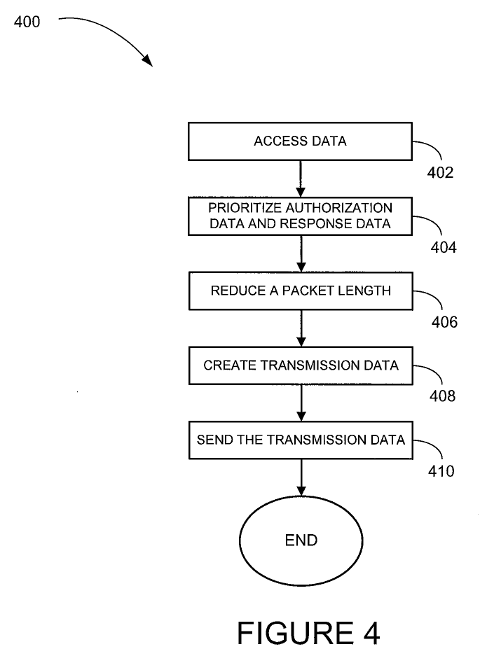

FIG. 4 illustrates a method 400 for sending transmission data according to an example embodiment. The method 400 may, for example, enable transmission data to be received by the user device 106 in close to real time to enable a response be triggered on the user device 106 that relates to presented programming material. The method 400 may be performed by the encoder 102 or another device.

Authorization data, response data and paging data is accessed at block 402. The response data and the authorization data is prioritized above the paging data for transmission at block 404. The response data may include gaming data (e.g., puzzle data for a gaming played on the user device 106), an addressable code, and/or other types of data.

A packet size (e.g., a packet length) may be reduced for the transmission data at block 406. Reduction of the packet size may enable the data to be sent to the user devices 106 more quickly.

Transmission data is created from the authorization data, response data and paging data according to prioritization at block 408. The transmission data may be of the reduced packet size or the original packet size. The transmission data is sent over the paging network 104 at block 410.

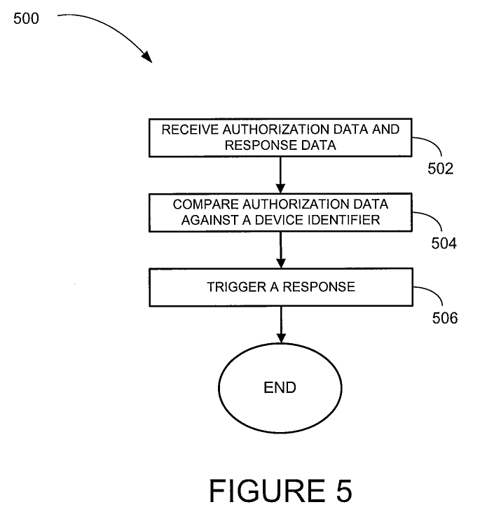

FIG. 5 illustrates a method 500 for method for triggering a response according to an example embodiment. The method 500 may be performed by the user device 106 or another device.

Authorization data and response data is received over the paging network 104 on the user device 106 at block 502.

The authorization data is compared against a device identifier of the user device 106 at block 504. The device identifier may be used to verify that the authorization data was intended for a particular user device 106.

At block 506, a response indicated by the response data is triggered on the user device 106 based on a comparison of the authorization data to the device identifier. The response may be an electronic coupon, an audible message, a multimedia message, a promotional code, or a combination thereof.

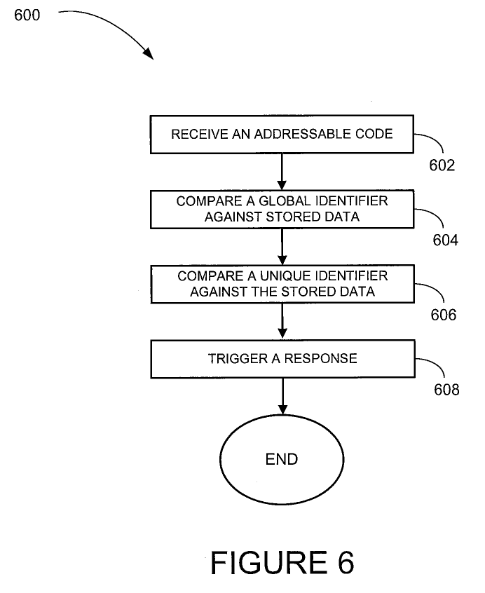

FIG. 6 illustrates a method 600 for method for triggering a response according to an example embodiment. The method 600 may be performed by the user device 106 or another device.

At block 602, an addressable code is received over the paging network on the user device 106. The addressable code may include a global identifier and a unique identifier.

A global identifier may be compared against stored data at block 604. The stored data may be received over the paging network 104 prior to receiving the authorization data, over a different network prior to receiving the authorization data, or in another way. The global identifier may be compared against at least one identifier of a tiered set of identifiers.

The unique identifier may be compared against the stored data at block 606. At block 608, a response may be triggered to the authorization data on the user device 106 based on the comparison performed at block 602 and/or block 604.

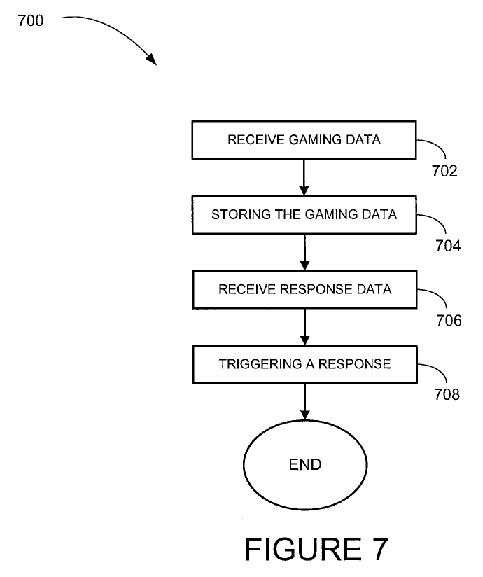

FIG. 7 illustrates a method 700 for method for triggering a response according to an example embodiment. The method 700 may be performed by the user device 106 or another device.

Gaming data may be received over the paging network 104 on the user device 106 at block 702. The gaming data may be stored on the user device 106 at block 704.

At block 706, response data may be received on the user device 106 during a presentation of programming material. The response data may be received over the paging network 104 or may be modulated within the programming material. For example, the response data may be included in a substantially invisible manner in a video signal (e.g., through modulation of scan lines) that is presenting the programming material. The response data may be received in other ways.

At block 708, a response may be triggered using the gaming data on the user device 106 based on the received response data. The response may be synchronized with the programming material.

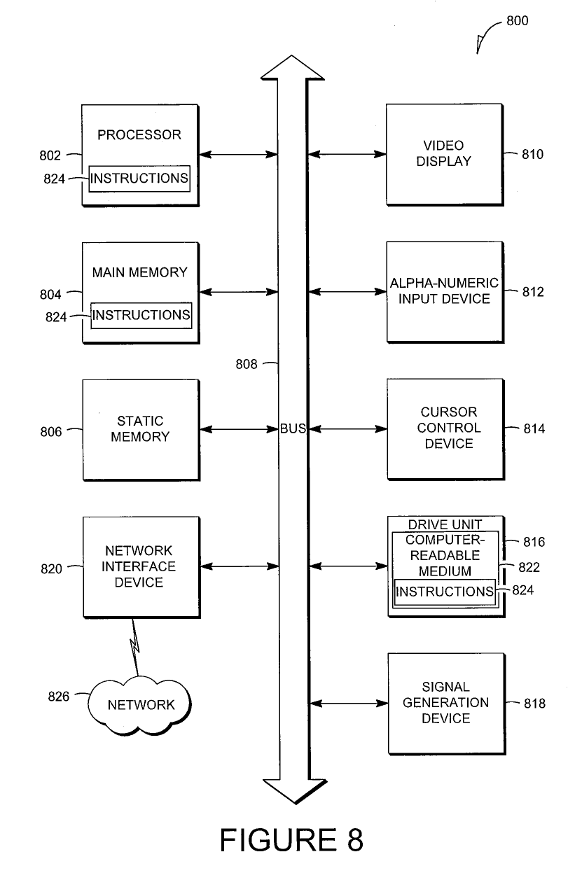

FIG. 8 shows a diagrammatic representation of machine in the example form of a computer system 800 within which a set of instructions may be executed causing the machine to perform any one or more of the methods, processes, operations, or methodologies discussed herein. The encoder 102 and/or the user devices 106.1-106.3 may include the functionality of the one or more computer systems 800.

In an example embodiment, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 800 includes a processor 802 (e.g., a central processing unit (CPU) a graphics processing unit (GPU) or both), a main memory 804 and a static memory 806, which communicate with each other via a bus 808. The computer system 800 may further include a video display unit 810 (e.g., a liquid crystal display (LCD) or a cathode ray tube (CRT)). The computer system 800 also includes an alphanumeric input device 812 (e.g., a keyboard), a cursor control device 814 (e.g., a mouse), a drive unit 816, a signal generation device 818 (e.g., a speaker) and a network interface device 820.

The drive unit 816 includes a machine-readable medium 822 on which is stored one or more sets of instructions (e.g., software 824) embodying any one or more of the methodologies or functions described herein. The software 824 may also reside, completely or at least partially, within the main memory 804 and/or within the processor 802 during execution thereof by the computer system 800, the main memory 804 and the processor 802 also constituting machine-readable media.

The software 824 may further be transmitted or received over a network 826 via the network interface device 820.

While the machine-readable medium 822 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to, solid-state memories, optical and magnetic media, and carrier wave signals.

Certain systems, apparatus, applications or processes are described herein as including a number of modules or mechanisms. A module or a mechanism may be a unit of distinct functionality that can provide information to, and receive information from, other modules. Accordingly, the described modules may be regarded as being communicatively coupled. Modules may also initiate communication with input or output devices, and can operate on a resource (e.g., a collection of information). The modules be implemented as hardware circuitry, optical components, single or multi-processor circuits, memory circuits, software program modules and objects, firmware, and combinations thereof, as appropriate for particular implementations of various embodiments.

Thus, methods and systems for response authorization have been described. Although embodiments of the present invention have been described with reference to specific example embodiments, it will be evident that various modifications and changes may be made to these embodiments without departing from the broader spirit and scope of the embodiments of the invention. Accordingly, the specification and drawings are to be regarded in an illustrative rather than a restrictive sense.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A method comprising:
accessing authorization data, response data and paging data;
prioritizing the response data and the authorization data above the paging data for transmission;
creating transmission data from the authorization data, response data and paging data according to prioritization; and
sending the transmission data over a paging network.

2. The method of claim 1, wherein the creating of the transmission data comprises:
reducing a packet size for the transmission data; and
creating the transmission data of the packet size from the authorization data, response data and paging data according to prioritization.

3. A method comprising:
receiving authorization data and response data over a paging network on a user device;
comparing the authorization data against a device identifier of the user device; and
triggering a response indicated by the response data on the user device based on a result of the comparing.

4. The method of claim 3, wherein the user device is a promotional device.

5. The method of claim 3, wherein the response is an electronic coupon, an audible message, a multimedia message, a promotional code, or combinations thereof.

6. A method comprising:
receiving an addressable code over a paging network on a user device, the addressable code including a global identifier and a unique identifier;
comparing the addressable code against stored data; and
triggering a response to the authorization data on a user device based on the comparing of the addressable code.

7. The method of claim 6, further comprising:
comparing the unique identifier against the stored data,
wherein the triggering of the response is based on the comparing of the addressable code and the unique identifier.

8. The method of claim 6, wherein the stored data is received over the paging network prior to receiving the authorization data.

9. The method of claim 6, wherein the stored data is received over a different network prior to receiving the authorization data.

10. The method of claim 6, wherein the stored data includes a tiered set of identifiers and the comparing comprises:
comparing the addressable code against the tiered set of identifiers to identify a particular identifier,
wherein the triggering of the response to the authorization data on the user device is based on the particular identifier.

11. The method of claim 10, wherein the paging network is a one-way paging network.

12. A method comprising:
receiving gaming data over a paging network on a user device;
storing the gaming data on the user device;
receiving response data on the user device during a presentation of programming material; and
triggering a response using the gaming data on the device based on the received response data, the response being synchronized with the programming material.

13. The method of claim 12, wherein the response data is received over the paging network.

14. The method of claim 12, wherein the response data is modulated within the programming material.

15. A machine-readable medium comprising instructions, which when implemented by one or more processors perform the following operations:
receive an addressable code over a paging network on a user device, the addressable code including a global identifier and a unique identifier;
compare the addressable code against stored data; and
trigger a response to the authorization data on a user device based on a comparison of the addressable code.

16. The machine-readable medium of claim 15, wherein the paging network is a one-way paging network.

17. The machine-readable medium of claim 15, wherein the user device is a promotional device.

18. A system comprising:
a data access module to access authorization data, response data and paging data;
a prioritization module to prioritize the response data and the authorization data above the paging data for transmission;
a transmission creation module to create transmission data from the authorization data, response data and paging data according to prioritization; and
a sending module to send the transmission data over a paging network.

19. The system of claim 18, further comprising:
a reduction module to reduce a packet size for the transmission data created by the transmission creation module.
